(19) United States
(12) Patent Application Publication
(10) Pub. No.: US 2008/0104225 A1
(43) Pub. Date: May 1, 2008

(54) VISUALIZATION APPLICATION FOR MINING OF SOCIAL NETWORKS

(75) Inventors: Heng Zhang, Bellevue, WA (US); Benyu Zhang, Beijing (CN); Teresa Mah, Bellevue, WA (US); Dong Zhuang, Beijing (CN); Jeremy Tantrum, Shoreline, WA (US); Ying Li, Bellevue, WA (US)

Correspondence Address: MICROSOFT CORPORATION;C/O LYON & HARR, LLP, 300 ESPLANADE DRIVE, SUITE 800, OXNARD, CA, 93036, US

(73) Assignee: Microsoft Corporation, Redmond, WA (US)

(21) Appl. No.: 11/555,279

(22) Filed: Nov. 1, 2006

(51) Int. Cl. G06F 15/173; G06F 15/177

(52) U.S. Cl. 709/224; 709/223; 715/734

(57) ABSTRACT

A social network visualization and mining system that includes a visualization application for mining social networks of users in an online social network. This visualization can be used to mine the social network for additional information and intelligence. The social network is displaying in graphical form, such as a node-link graph, with a center node representing the social network of a user being examined, and secondary nodes represent the primary user's friends. Lines represent links between the primary user and his friends, while various visualization features such as line thickness, line color, and text size are used to easily identify the type of relationship between users. The system also includes a topics visualization module, which builds and displays a social network based on a certain topic or keyword that is entered by the application user. A demographic prediction module examines a user's social network to predict demographics of users.

### BACKGROUND

Online social networks are communities on the Internet where people can come together to exchange information, ideas, and opinions. These online social networks (such as MSN Spaces) are rich with user-created text content, imported pictures, and music. In addition, several users of the online social network maintain a blog. In general, a blog is an online publication with regular posts, presented in reverse chronological order. The contents of a social network user's blog may concern any aspect of daily life, such as news, politics, business, science. In addition, these blogs frequently act as a personal diary to record the user's interests, opinions and events.

Most online social networks are quite large in scale. For example, one online social network has more than 58 million users. These users interconnect with each other, which builds up a very rich and useful social network for each user. A user's social network is his compilation of online friends. This personal social network may contain hundreds or even thousands of other users, along with complex and often unique links between the user and a friend. For example, a link between the user and an online friend may range from a casual acquaintance to close family member. The link does not even need to be user initiated. It may simply be another user in the community viewing the user's blog.

It is quite desirable to be able to analyze and mine information from a user's social networks within an online social community. For example, mining information about user-created content on blogs and each user's social network enables advertisers to better understand the different user groups within the community. The ultimate goal of the advertiser is more efficient ad targeting and product improvement. This mining provides an advertiser with rich and valuable intelligence to better understand social network users, optimize viral marketing, refine ad targeting, and expand behavioral segments. One problem, however, is that there is currently a dearth of application (or end-user software) that allows an application user to visualize a user's social network and to mine the social network for information about the users and their interconnected online social relationships.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The social network visualization and mining system includes a visualization application for mining social networks of users in an online social community. In general, the social network visualization and mining system display a graphic of a user's social network in a manner that is both efficient and useful. Moreover, this visualization can be used to mine the social network for additional information and intelligence. The mining of information includes the examination of user-created content and the relationships between users.

The social network visualization and mining system has several applications, including providing advertisers with knowledge and information about potential consumers to enable targeted advertising. By using the social network visualization and mining system, an advertiser can target its advertising of a product to obtain the highest return on its investment. The social network visualization and mining system may also be used to analyze and visualize other types of communities and networks.

The social network visualization and mining system includes a social network visualization module that displays the social network to an application user in graphical form. Smooth and effective user interfaces help the application user easily change focus between different users. In one embodiment, a two-dimensional (2-D) node-link graph is used to display the social network of a user. A center node is used to represent the primary social network user being examined, and secondary nodes represent the primary user's friends. Lines are used to represent the links between the primary user and these friends. Various visualization features such as line thickness, line color, and text size are used enable the application user to easily identify the type of link between the primary user and his friends. In another embodiment, the structure of a social network is displayed in a layered tree format.

The social network visualization and mining system also includes a topics visualization module. This module builds and displays a social network based on a certain topic or keyword that is entered by the application user. For example, an advertiser may want to know which users are interested in baby products. A topic or keyword search by the advertiser may include the term “diapers” in order to identify users who are parents. The social network of each user interested in this topic then may be visualized using the social network visualization module. This visualization is an excellent target community for viral marketing campaigns and ad targeting of relevant products or services.

The social network visualization and mining system also includes a demographic prediction module. Many users in an online social community give no or false demographic information. However, it can be important to advertisers to know the age, location, and gender of users. The demographic prediction module examines a user's social network to predict the demographics of the user. This allows an advertiser to use the social network visualization and mining system to target advertising by demographics to connect to the right audience.

It should be noted that alternative embodiments are possible, and that steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a block diagram illustrating an exemplary implementation of the social network visualization and mining system disclosed herein.

FIG. 2 is a flow diagram illustrating the general operation of the social network visualization and mining system shown in FIG. 1.

FIG. 3 illustrates a first embodiment of a user interface of the social network visualization and mining system shown in FIG. 1.

FIG. 4 illustrates a second embodiment of a user interface that uses a tree-building technique to transform the social network from a node-link graph into a tree format.

FIG. 5 illustrates a third embodiment of a user interface for the topics visualization module for a specific topic.

FIG. 6 illustrates a fourth embodiment of a user interface for the topics visualization module for a specific user.

FIG. 7 illustrates a fifth embodiment of a user interface for the demographic prediction module.

FIG. 8 illustrates an example of a suitable computing system environment in which the social network visualization and mining system may be implemented.

### DETAILED DESCRIPTION

In the following description of the social network visualization and mining system, reference is made to the accompanying drawings, which form a part thereof, and in which is shown by way of illustration a specific example whereby the social network visualization and mining system may be practiced. It is to be understood that other embodiments may be utilized and structural changes may be made without departing from the scope of the claimed subject matter.

### I. System Overview

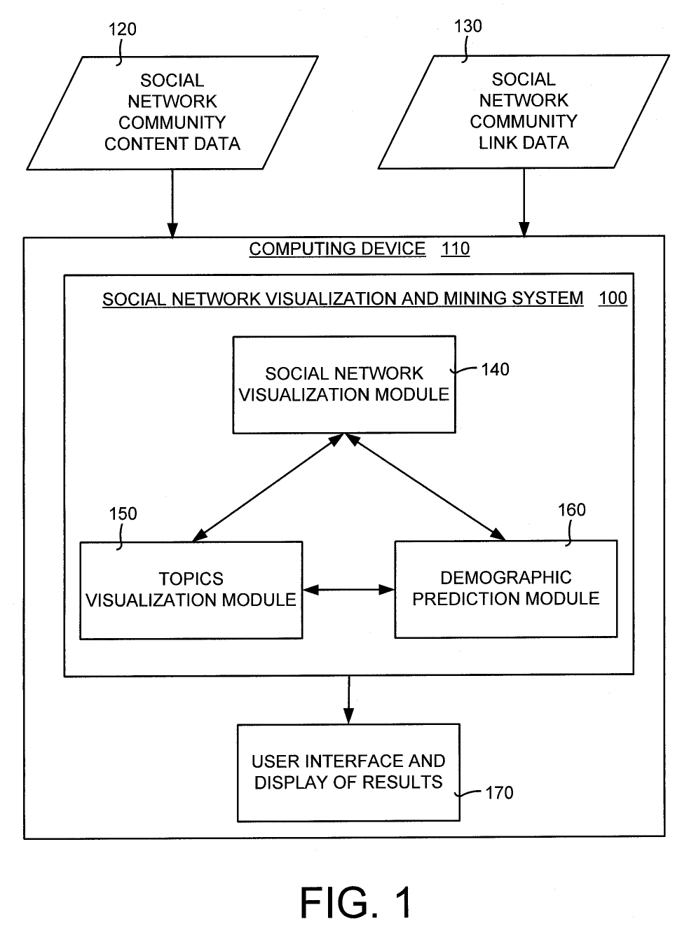

FIG. 1 is a block diagram illustrating an exemplary implementation of the social network visualization and mining system 100 disclosed herein. It should be noted that FIG. 1 is merely one of several ways in which the social network visualization and mining system 100 may be implemented and used. The social network visualization and mining system 100 may be implemented on various types of processing systems, such as on a central processing unit (CPU) or multi-core processing systems.

Referring to FIG. 1, the social network visualization and mining system 100 is designed to run on a computing device 110. It should be noted that the social network visualization and mining system 100 may be run on numerous types of general purpose or special purpose computing system environments or configurations, including personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like. The computing device 110 shown in FIG. 1 is merely meant to represent any one of these and other types of computing system environments or configurations.

As shown in FIG. 1, input to the social network visualization and mining system 100 includes social network community content data 120 and social network community link data 130. The content data 120 is meant to represent any content within the online social community. This content includes user-created content (such as blogs), timestamps, user identifications, chat session data, demographic data, and so forth. The link data 130 is meant to represent any data that can be used to determine the type of relationship between users. It is possible that the link data 130 and the content data 120 can overlap.

The social network visualization and mining system 100 includes several interconnected modules. These modules include a social network visualization module 140, a topics visualization module 150, and a demographic prediction module 160. The social network visualization module 140 provides the application user (of the social network visualization module 140 application) with a graphical representation of a user's social network. As explained in detail below, in one embodiment this graphical representation is a node-link graph. In another embodiment, the representation is in a layered tree format.

The topics visualization module 150 provide the application user with the ability to search for user social network via topic or keyword. As explained below, this gives the application user the ability to find users with the same interests. The demographic prediction module 160 makes predictions about a user's demographics (such as age, location, and gender). These predictions are based on the social network of a user and the demographic information of the user's friends. Each of these modules outputs their results and graphical displays to a user interface 170 for display of results to the application user.

### II. Operational Overview

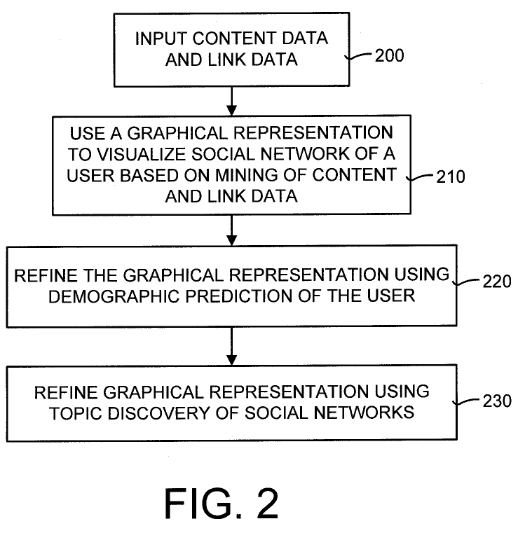

FIG. 2 is a flow diagram illustrating the general operation of the social network visualization and mining system shown in FIG. 1. In general, the social network visualization and mining method collects data from an online social network community and present information about the social network of users in a graphical form. More specifically, the social network visualization and mining method collects and inputs content data and link data from the online social network community (box 200).

Next, a graphical representation is used to visualize the social network of a user (box 210). The graphical representation is based on the content and link data. In one embodiment, the graphical representation is a node-link graph. Moreover, in some embodiments, the node-link graph is a hypergraph, which is an open source project. This type of graph allows an application user to easily explore a user's social network, and quickly see links between the user and his friends. In addition, the user can be changed in order to visualize another user's social network. In another embodiment, the node-link graph may be transformed into a layered tree format.

The graphical representation can be refined using a demographic prediction technique (box 220). If the user be examined did not give any demographic data, or the data is suspect, then the social network visualization and mining method predicts the user's age, location, and gender based on the demographic data of the user's friends and the user's social network. Additional refinement of the graphical representation is possible using topic discovery (box 230). Topic discovery allows displays social network based on a desired topic or keyword, such that displayed users are interested in the topic.

### III. Operational Details

### Social Network Visualization

The social network visualization and mining system includes a social network visualization module. The social network visualization module represents each social network as a node-link graph. Each node of the node-link graph represents a user and each link represents a relationship between users. The relationship can be any type of social network interaction, such as an e-mail, blog, or instant messenger interaction. The social network visualization module allows the visualization of the way in which users are linked in a social network that set that is quite difficult to see in its raw data form.

In one embodiment, the social network visualization module presents the structure of a social network in two-dimensional (2-D) space as a 2-D node-link graph. This 2-D node-link graph includes several features, including the ability to: (1) present the graph with various styles of nodes and edges (or lines); (2) handle a large-scale social network; and (3) present the social network structure in multiple forms.

### Various Styles of Nodes and Edges

In one embodiment of the social network visualization module, the nodes represent users in the social network. In this embodiment, the nodes are associated with a user identification (user ID). The position of a node in the 2-D node-link graph determines the structure and the shape of the graph. Each node is shown as a point (or dot) on the graph, while the user associated with a particular node is labeled as text (typically the user ID) near the node. Various colors and fonts are available for this text. In addition, in some embodiments the size of the text is used to indicate the distance between a center node and outlying nodes. The center node, which is capable of being changed by an application user, identifies the node currently being examined while the outlying nodes are those nodes in the social network of the user represented by the center node.

Lines are another element of the 2-D node-link graph, and are used to represent types of links between users. In other words, the type of social relationship between two users is indicated by the type of line used to join the two nodes representing the users. In one embodiment of the social visualization module, the lines are solid. In other embodiments the width of a line can be used to indicate the importance of the social relationship between users. By way of example, in some embodiments a thicker line represents a stronger relationship between users, while a thinner line represents a weaker relationship (as compared to the thicker line).

In some embodiments, line color can also be used to represent various types of relationships between users. In one embodiment, an orange line indicates a “user-defined friend”, a green line indicates a “page view” (or someone who has visited the users blog or web page), a light blue line indicates a “blog comment” (or someone who has comment on the user's blog), a purple line indicates a “blog trackback”, a yellow line indicates an “IM chat”, and a dark blue line indicates a “mixture”, meaning that there are no less than two kinds of the above types of relationships between users.

In another embodiment, special layouts, such as shadows, can be used to indicate different node clusters. In another embodiment, icons can be used to indicate how many neighbors there are for the user node. In one embodiment, an icon having one star indicates that the user node has only a few neighbors, an icon having three stars indicates that the user node has a moderate amount of neighbors (as compared to the icon having one star), and an icon having six stars indicates that the user node has many neighbors (as compared to the icon having one star and the icon having three stars.

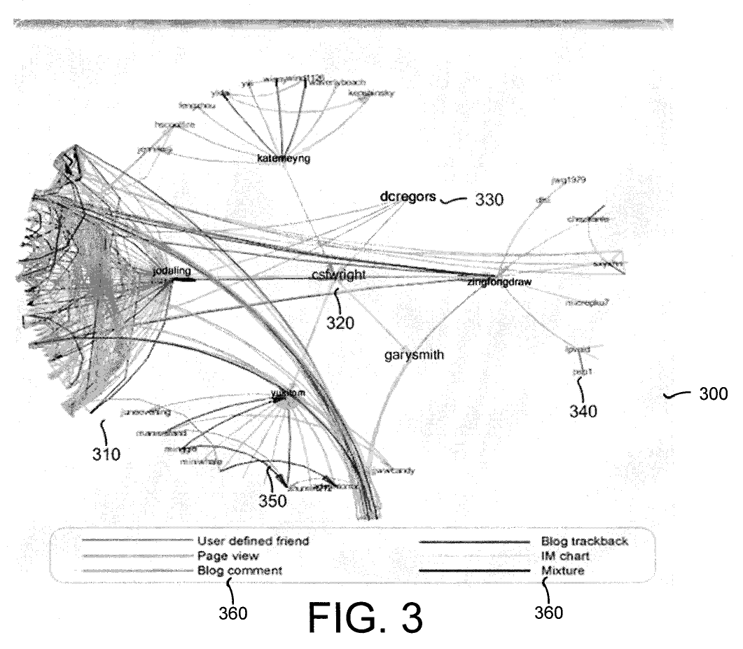

FIG. 3 illustrates a first embodiment of a user interface 300 of the social network visualization and mining system shown in FIG. 1. The user interface 300 illustrates a node-link graph 310 that visualizes a social network of a user, designated by a center node 320. A first node 330 having larger text indicates that the first node is closer to the center node 320 than a second node 340 having smaller text, as compared to the text of the first node 330. As stated earlier, the text indicates the user's identification within the online social community. As shown in FIG. 3, a line with an arrow 350 indicates a directed link. A link between uses may be direct or undirected. One example of a directed link is a user commenting on another's blog. An example of an undirected connection is two users chatting with each other. A directed link means that user A knows user B, but user B does not necessarily know user A. On the other hand, an undirected link means that user A know user B and user B knows user A. A legend 360 indicates the meaning of each line color on the 2-D node-link graph 310.

### Handling Large-Scale Network

The social network visualization module is capable of displaying a social network having up to 1,000 nodes. In addition, the complicated lines among nodes can also be illustrated for those up to 1,000 nodes on a node-link graph. The social network visualization module optimizes the node positions so that the line structure is visualized in a clear and elegant way.

### Display Network Structure in Multiple Formats

The social network visualization module is capable of displaying a social network in a variety of display formats. In one embodiment, the social network is displayed in raw format. In another embodiment, the social network is displayed in a tree format. This tree format presents a social network user's social network connections in a hierarchical structure that conveys a clear and organized view of how other social network users are connected to this specific social network user.

In order to reorganize connections of social network user from the raw format to a tree format, the social network visualization module includes a tree building technique. In one embodiment, this tree building technique uses a layered approach. For example, suppose that all direct connections of a user node U corresponding to a social network user are selected and laid out on a first layer of a node-link graph. Next, a different user node A on the first layer is randomly selected. All direct connections of the user node A that are not yet displayed on the graph then are will be laid out as the first layer of user node A (and the second layer of user node U). This process is repeated for a remainder of user nodes on the first layer. The same process is used to extend to the third layer and any additional layers. The tree building technique is completed when all nodes are put in the tree.

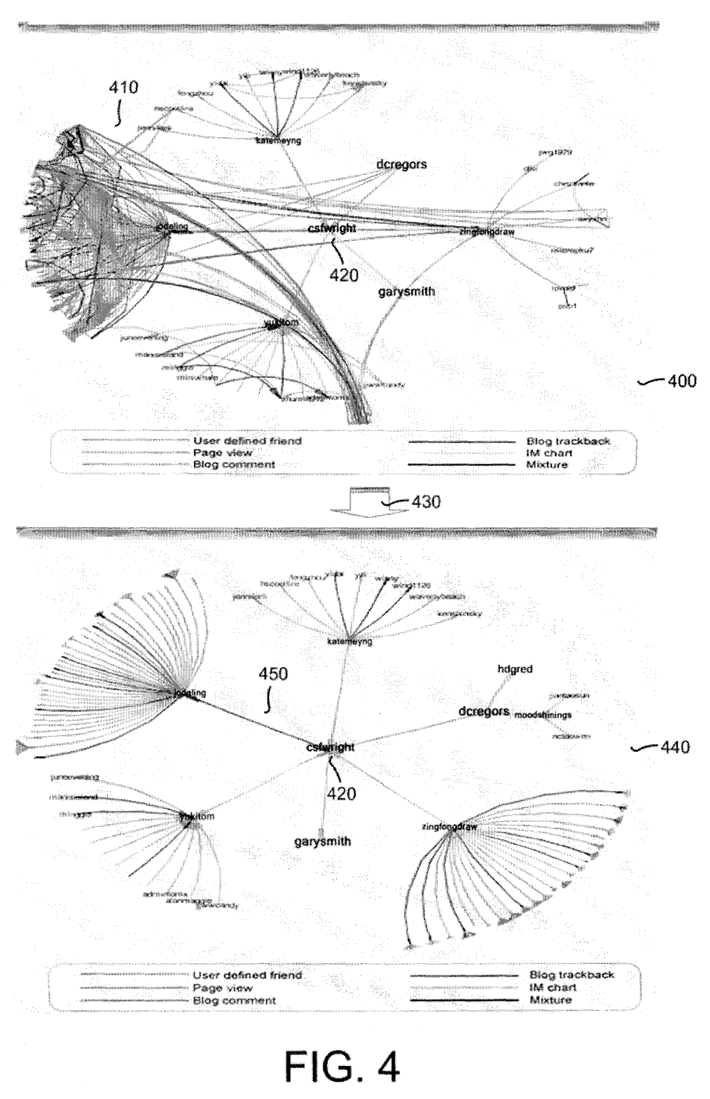

FIG. 4 illustrates a second embodiment of a user interface that uses a tree-building technique to transform the social network from a node-link graph into a tree format. As shown in FIG. 4, the top user interface 400 contains a second 2-D node-link graph 410 for a center node 420. The arrow 430 indicates a transformation to a bottom user interface 440 containing the same information as the top user interface 400, but in a tree format 450.

### Identifying Social Networks by Topic

The social network visualization and mining system includes a topics visualization module. In one embodiment, the topics visualization module allows the identification of groups of users having common interests and the connections among them. By way of example, social networks can be built for social network users who are blogging about the topic “xbox”. In one embodiment, the topics visualization module displays the largest isolated social network identified. In such an embodiment, the node in the middle of the node-link graph is the user having the most outgoing links.

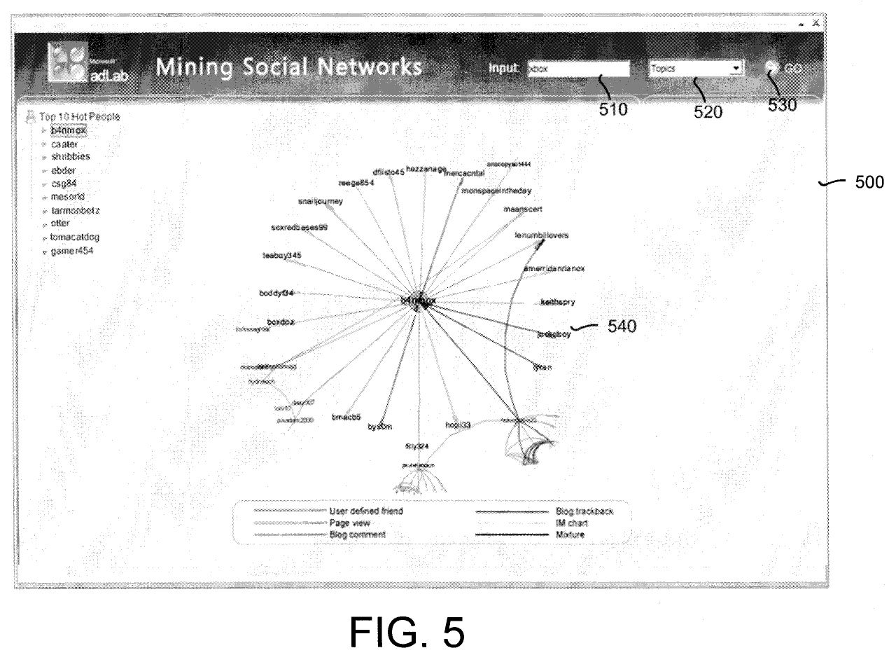

FIG. 5 illustrates a third embodiment of a user interface for the topics visualization module for a specific topic. As shown in FIG. 5, a topics user interface 500 includes a first input box 510 where topic can be entered. For example, to view a social network of users interested in “xbox”, FIG. 5 shows the term “xbox” entered in the first input box 510. Next, the application user inputs “TOPICS” into the second input box 520. This first input box 510 is where a type of identifier (such as “TOPICS”) can be entered. The application user then clicks the “Go” button 530 in order to visualize the results 540. These results represent the largest isolated social network of users that are interested in “xbox”.

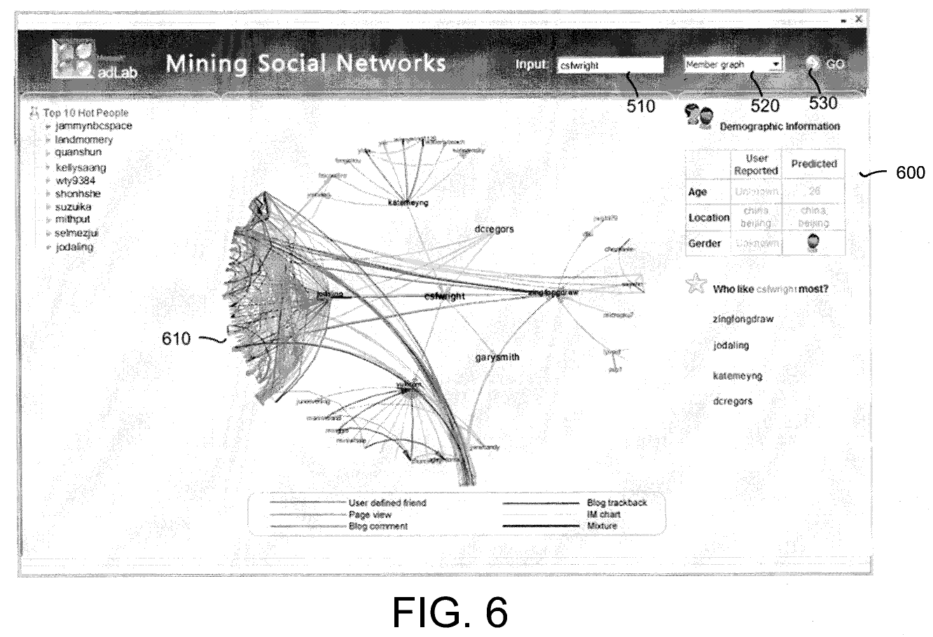

In another embodiment, the topics visualization module can identify a social network user's complete extended social network and visualize it up to certain network layers. FIG. 6 illustrates a fourth embodiment of a user interface for the topics visualization module for a specific user. As shown in FIG. 6, a specific user interface 600 includes the first input box 510 and the second input box 520. In order to view the social network of a specific social network user, the application user inputs into the first input box 510 the desired user's identification number. This identification number includes the membership number of the user on the social network. The application user then selects “Member graph” in the dropdown list of the second input box 520, and then clicks the “Go” button 530. The specific user interface 600 then present to the application user the specific user's social network 610 in the form of a node-link graph.

### Demographic Prediction

The social network visualization and mining system includes a demographic prediction module that predicts the demographics of a social network user, even if the user has not provided or has provided erroneous demographic information. This demographic information includes age, location, and gender. Not all social network users provide their demographic information, and for those that do, some users may provide information that is not true. The demographic prediction module predicts these users' demographic features using their social network structures and blog contents.

Accurately predicting demographic information for a user can be quite beneficial for the application user who is an advertiser. By targeting to the right demographic group, an advertiser is more likely to find social network users that are interested in their products and willing to click on their advertisements. Moreover, users are more likely to accept advertisements delivered through their blogs that match their interests. By way of example, an 18 year-old male blogger typically will be much happier to see an xBox advertisement on his blog page rather than an advertisement for dentures.

In addition, knowing the age and gender of social network users allows an advertiser to message appropriately to different demographic groups. For example, in some case, women tend to use different terminology as compared to men, and respond better to advertisements having a more female oriented message. Location targeting can help businesses that rely on local traffic to reach locally relevant social network users.

In one embodiment, the demographic prediction module is used to evaluate the demographic distributions of users who are interested in a certain topic or keyword. The results can serve as a powerful demographic targeting suggestion tool for advertisers to optimize their advertisement campaigns. By way of example, an advertiser may be interested in bidding for the keyword “women shoes”. If the demographic prediction module shows a 4/1 ratio for female versus male users interested in the topic within the social network, then the advertiser can choose to target female users only. Demographic distributions calculated using other data sources, such as search terms, can be used for the same purpose as well.

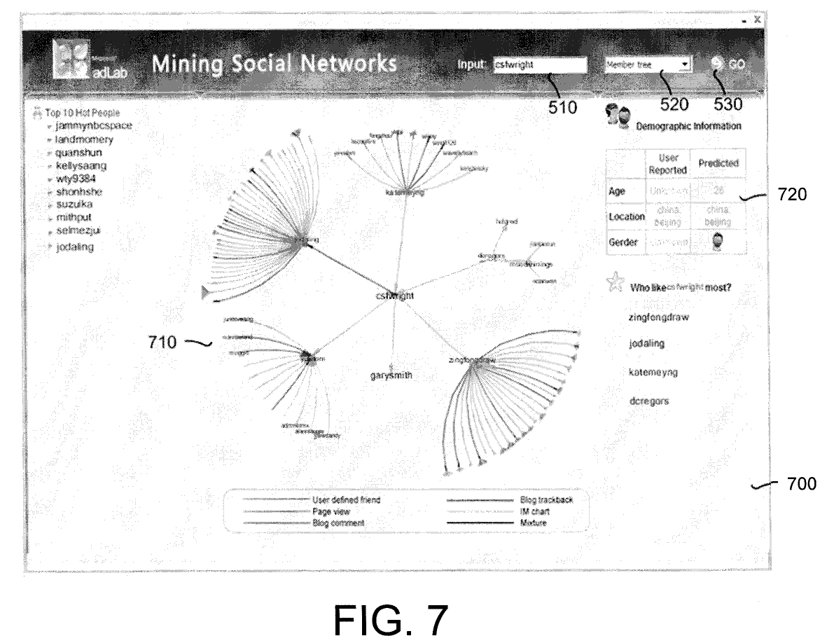

FIG. 7 illustrates a fifth embodiment of a user interface for the demographic prediction module. As shown in FIG. 7, a demographic prediction user interface 700 includes the first input box 510 and the second input box 520. The first input box 510 contains the name of the user on whom demographic prediction will be performed. The second input box 520 indicates how the results will be displayed. As shown in FIG. 7, a social network 710 for the user “csfwright” is shown in tree form. Moreover, a summary table 720 is displayed on the demographic prediction user interface 700. In this embodiment, the summary table 720 illustrates the user's age, location, and gender in a “User Reported” column (or as reported by the user) and in a “Predicted” column (as predicted by the demographic prediction module. As shown in FIG. 7, the demographic prediction module has predicted user “csfwright” to be male, 25 years of age, and living in the city of Beijing, China.

### Age Prediction

The demographic prediction module predicts the age of a social network user by assuming that the user is approximately the same age as his or her friends within the social network. Typically, a greater percentage of social network users are younger adults. These younger users are more likely to have friends in the same age group as compared to older users.

In order to predict a user's age, the demographic prediction module determines all friends of a user based on that user's social network structure. In one embodiment, if a user has at least three direct neighbors with known ages, then they demographic prediction module predicts the user's age to be the median of all the neighbors' ages. In this embodiment, the median is selected as the prediction because not only is it simple to understand and easy to calculate, but also because it gives a measure that is more robust in the presence of outlier values than the mean. By way of example, consider a 21 year-old female having seven friends ages 19, 20, 21, 21, 21, 22, 22, 23 and 55. Assume that the first eight are high school and college friends, while the last friend is her uncle. In this case, the prediction of the demographic prediction module is age 21, while taking the mean yields a predicted age of 25.

### Location Prediction

Similar to age prediction, the demographic prediction module predicts a user's I location by assuming that a user's friends generally reside in the same local area as the user. Thus, in one embodiment, a user's location is predicted by voting between the locations recorded in his/her neighbors' profiles. The location is predicted as the major location of a user's neighbors.

### Gender Prediction

The demographic prediction module uses a social network blog categorization technique to predict a user's gender. This categorization technique allows each blog to be categorized into one or more predefined categories. In addition, in one embodiment, there are assigned probabilities of “male” and “female” for each category. In this embodiment, the demographic prediction module sums the probabilities of each category for male and female and obtains a probability of a user's gender. In other embodiments, instead of using categories other identifiers can be used, such as keywords extracted from blogs, the most frequent terms used by the user, and the user's age and their neighbors' gender information.

### IV. Exemplary Operating Environment

The social network visualization and mining system is designed to operate in a computing environment. The following discussion is intended to provide a brief, general description of a suitable computing environment in which the social network visualization and mining system may be implemented.

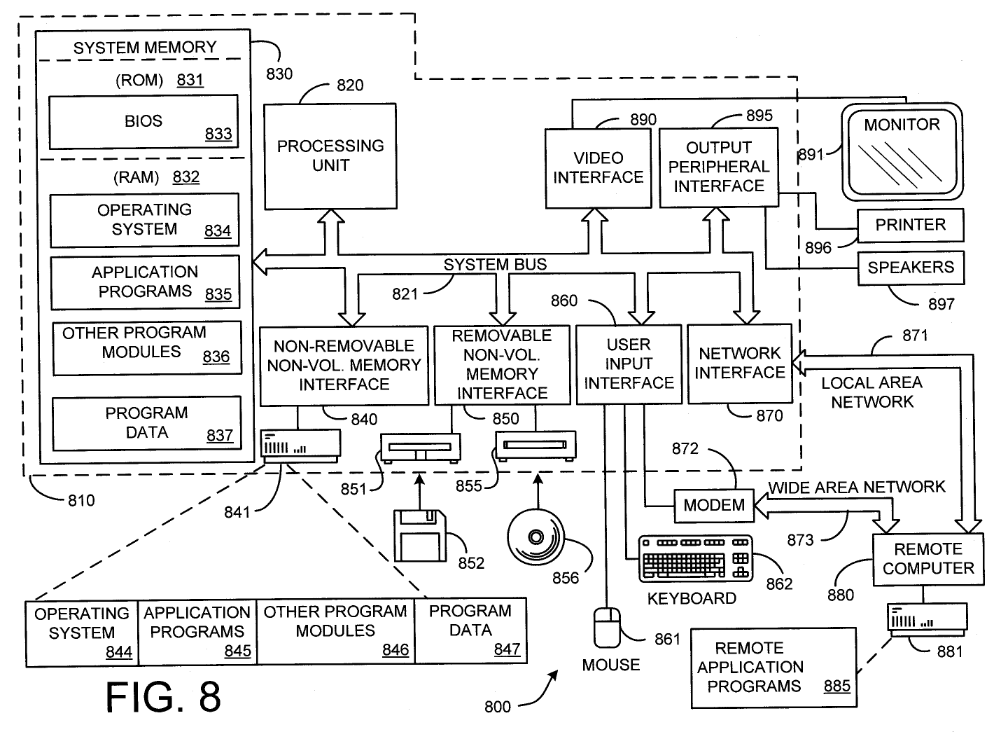

FIG. 8 illustrates an example of a suitable computing system environment in which the social network visualization and mining system may be implemented. The computing system environment 800 is only one example of a suitable computing environment and is not intended to suggest any limitation as to the scope of use or functionality of the invention. Neither should the computing environment 800 be interpreted as having any dependency or requirement relating to any one or combination of components illustrated in the exemplary operating environment.

The social network visualization and mining system is operational with numerous other general purpose or special purpose computing system environments or configurations. Examples of well known computing systems, environments, and/or configurations that may be suitable for use with the social network visualization and mining system include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The social network visualization and mining system may be described in the general context of computer-executable instructions, such as program modules, being executed by a computer. Generally, program modules include routines, programs, objects, components, data structures, etc., that perform particular tasks or implement particular abstract data types. The social network visualization and mining system may also be practiced in distributed computing environments where tasks are performed by remote processing devices that are linked through a communications network. In a distributed computing environment, program modules may be located in both local and remote computer storage media including memory storage devices. With reference to FIG. 8, an exemplary system for the social network visualization and mining system includes a general-purpose computing device in the form of a computer 810.

Components of the computer 810 may include, but are not limited to, a processing unit 820 (such as a central processing unit, CPU), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 810 typically includes a variety of computer readable media. Computer readable media can be any available media that can be accessed by the computer 810 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 810. Communication media typically embodies computer readable instructions, data structures, program modules or other data in a modulated data signal such as a carrier wave or other transport mechanism and includes any information delivery media.

Note that the term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within the computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. A user may enter commands and information into the computer 810 through input devices such as a keyboard 862 and pointing device 861, commonly referred to as a mouse, trackball or touch pad.

Other input devices (not shown) may include a microphone, joystick, game pad, satellite dish, scanner, radio receiver, or a television or broadcast video receiver, or the like. These and other input devices are often connected to the processing unit 820 through a user input interface 860 that is coupled to the system bus 821, but may be connected by other interface and bus structures, such as, for example, a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on memory device 881. It will be appreciated that the network connections shown are exemplary and other means of establishing a communications link between the computers may be used.

The foregoing Detailed Description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A method for visualizing data a social network, comprising:
collecting content and link data about users in the social network;
visualizing the content and link data graphically using a graphical representation to visualize a social interaction of the users in the social network; and
mining the social network using the graphical representation for addition information, other than content and link data, about the users in the social network,
wherein content data is any content within the social network including user-created content, timestamps, user identifications, chat session data, and demographic data;
wherein link data is any data that can be used to determine a type of relationship between users.

2. The method of claim 1, further comprising using a node-link graph as the graphical representation.

3. The method of claim 2, wherein the node-link graph is a two-dimensional (2-D) node-link graph.

4. The method of claim 1, further comprising predicting demographics of a user on the social network prediction based on the user's social network structure and blog contents.

5. The method of claim 4, wherein predicting demographics of the user further comprises determining an age of the user by assuming that the user is approximately a same age as the user's friends on the social network.

6. The method of claim 5, wherein predicting demographics of the user further comprises determining a location of the user by assuming that the user's friends on the social network generally reside in a same local area as the user.

7. The method of claim 6, wherein predicting demographics of the user further comprises determining a gender of the user by categorizing a blog of the user.

8. The method of claim 1, further comprising refining the graphical representation using topic discovery to identifying groups of user on the social network having common interests, such that the graphical representation visualizes a social network of the users in the social network relating to a certain topic.

9. The method of claim 8, further comprising identifying the certain topic using a graphical user interface.

10. The method of claim 2, further comprising:
using nodes to represent each user in the social network, wherein a position of a node in the node-link graph determine a structure and shape of the node-link graph;
labeling each node with text having various text fonts and colors available; and
using text size to visually indicate a distance between a center node and outlying nodes on the node-link graph.

11. The method of claim 10, further comprising:
connecting the center node to the outlying nodes using lines to represent links between a user and the friends of the user; and
using a width of each line to indicate an importance of a relationship between the user and the friends, such that a thicker line is indicative of a stronger relationship between the user and a certain friend, and a thinner line is indicative of a weaker relationship, as compared to the thicker line.

12. The method of claim 11, further comprising using a line color to indicate a relationship type between the user and the friends of the user, as follows: (a) an orange line indicates a user-defined friend; (b) a green line indicates a page view, meaning that a friend of the user has visited a blog or web page of the user; (c) a light blue line indicates a blog comment, meaning that a friend of the user has commented on the user's blog; (d) a dark blue line indicates a mixture, meaning that there are no less than two kinds of the relationships described in (a) through (c).

13. A computer-readable medium having computer-executable instructions thereon for visualizing and mining an online social network, comprising:
collecting and inputting content data and link data for each of user in the online social network, wherein content data is any content contained in the online social network, and link data is any data used to determine a type of relationship between users in the online social network;
visualizing the online social network using a two-dimensional node-link graph such that a center node represents a user being examined, outlying nodes represent other users in the social network of the user being examined, and line between the center node and outlying nodes represent the type of relationship between the user being examined and the other users in the social network of the user being examined; and
mining the two-dimensional graphical representation of the online social network to obtain information that can be used to target advertising of a product to potentially interested users in the online social network.

14. The computer-readable medium of claim 13, further comprising predicting demographics of the user being examined based on the social network of the user being examined and contents of the blog of the user being examined.

15. The computer-readable medium of claim 14, further comprising predicting an age of the user being examined by finding at least three users in the social network of the user being examined having known ages and calculating the user's age as a median of all the known ages.

16. The computer-readable medium of claim 15, further comprising predicting a gender of the user being examined by categorizing blogs of each of the users in the social network of the user being examined into one or more predefined categories, assigning a probability of “male” or “female” to each of the predefined categories for each blog, and summing the probabilities to obtain a probability of the gender of the user being examined.

17. A computer-implemented process for visualizing an online social network having a plurality of users, comprising:
obtaining content data and link data for each of the plurality of users, wherein the content includes user-created content, blogs, web pages, timestamps, user identifications, chat session data, and demographic data in the online social network, and link data includes a type of relationship between the plurality of users;
selecting one of the plurality of users as the user being examined;
representing social network of the user being examined as a two-dimensional node-link graph having at its center a center node representing the user being examined, and outlying nodes representing users in a social network of the user being examined; and
predicting demographics of the user being examined based on the user's social network.

18. The computer-implemented process of claim 17, further comprising:
entering a desired topic in a graphical user interface; and
placing at the center node a user having a greatest number of discussions with other users about the desired topic.

19. The computer-implemented process of claim 17, further comprising:
connecting the center node with each of the outlying nodes using lines having various colors and thicknesses;
using a line having with an arrow on one end of the line to represent a directed link between two users; and
using a line without an arrow to represent an undirected link between the two users;
wherein a directed link means that one of the two users knows the other user, but not vice versa, and an undirected link means that both of the two users know each other.

20. The computer-implemented process of claim 19, further comprising using a tree building technique to transform the two-dimensional node-link graph into a multi-layer tree format, the tree building technique further comprising:
displaying each directed link of the user being examined in a first layer of the tree format;
randomly selecting another user node in the first layer other than the user being examined,
displaying directed links of the selected user in a second layer; and
repeating the above steps for each node in the first layer, without repeating users, to create the multi-layer tree format.
